(19) United States
(12) Patent Application Publication
(10) Pub. No.: US 2013/0115357 A1
(43) Pub. Date: May 9, 2013

(54) INSTANT SHELF-STABLE WHITENED LIQUID BEVERAGE CONCENTRTATE AND METHODS OF MAKING THEREOF

(71) Applicant: ALY GAMAY, McClean, VA (US)

(72) Inventor: ALY GAMAY, McClean, VA (US)

(21) Appl. No.: 13/664,145

(22) Filed: Oct. 30, 2012

Related U.S. Application Data
(60) Provisional application No. 61/556,192, filed on Nov. 5, 2011.

(51) Int. Cl. A23L 2/385

(52) U.S. Cl. CPC A23L 2/385
USPC 426/548; 426/392

(57) ABSTRACT

Disclosed is a composition and method of preparing compositions which provide a stabilized, ultra-concentrated liquid whitened beverage which is shelf-stable at room temperature without the need for refrigeration or freezing. This invention further relates to a process for manufacturing sugar-free, protein-free and buffering agent-free concentrated stabilized whitened liquid beverage with enhanced aroma and flavor. The liquid beverage concentrate is also resistant to microbial growth without the need for additional preservatives, thereby enabling storage at ambient temperatures.

### CROSS-REFERENCE TO RELATED APPLICATIONS

This application claims the benefit of U.S. Provisional Application No. 61/556,192, filed Nov. 5, 2012. The entire disclosure of this prior application is hereby incorporated by reference.

### FIELD OF INVENTION

The present invention is generally related to the field of beverages, and more particularly to the making of an instant shelf-stable whitened liquid beverage concentrate. More specifically, the present invention is directed to a technique of stabilizing an ultra-concentrated liquid whitened beverage to make it shelf-stable at room temperature without the need for refrigeration or freezing. This invention further relates to a process for manufacturing sugar-free, protein-free and buffering agent-free concentrated stabilized whitened liquid beverage with enhanced aroma and flavor. The liquid beverage concentrate is also resistant to microbial growth without the need for additional preservatives, thereby enabling storage at ambient temperatures.

### BACKGROUND OF THE INVENTION

This invention pertains to an instant shelf-stable whitened liquid beverage concentrate having low viscosity that is shelf-stable, resistant to microbial growth, and can be stored at ambient temperatures. The concentrate is sugar-free, protein-free and buffering agent-free and does not contain dairy or non-dairy creamers as compared to other similar concentrates currently available.

Single serve bottled and canned beverages are very popular. However, the cost of packaging, shipping, and storage costs is extremely high, and may require refrigeration to increase shelf life.

The beverage industry produces powders to reduce the cost of handling various hot beverage products. However, hot beverages prepared from powders may be of a lower quality compared to ready-to consume products due to insufficient or improper mixing and dilution of the powder. Although dry mixes or powdered and crystalline formulations are most desirable in terms of transportation and storage, the dry mixes frequently produce beverages with inferior taste and feel due to the difficulties in obtaining complete rehydration and mixing.

Liquid concentrates in bulk packaging are used to deliver various beverages to the consumer in a convenient manner. Using high concentration of beverage liquids, which are then diluted at the final dispensing location, reduces shipping costs by eliminating the cost of shipment of water. Beverages prepared from liquid concentrates are more desirable. Liquid concentrates may also require special storage conditions, particularly after being opened. Current industry practices use heat processing technology, such as retort or Ultra High Temperature (UHT) or aseptic technologies, to produce shelf-stable bulk liquid beverage concentrates. These shelf stable beverage concentrates generally have a neutral pH. Thus, when the beverage concentrate container is opened for use, the growth of most microorganisms within the concentrate is supported and the beverage product is highly susceptible to contamination and spoilage. This in turn limits the shelf life of the single strength or reconstituted product.

Recently specialized beverage drinks have become popular. Mocha, espresso, cafe latte, cappuccino, Chai, chocolate, and the like, require preparation techniques not readily and reliably practiced in the consumer setting, and accordingly are available primarily only at commercial settings having specialized equipment and personnel for such products. Also, flavored cold coffees are becoming popular and require coffee concentrates that will maintain desired flavor in the presence of dilution with ice and additives. No instant flavored liquid beverage concentrates that contains whitening agent have been made available to consumers for use at home or on the go.

In an effort to provide the consumer and the commercial establishment with a wide variety of hot and cold beverage based beverages that can be reliably and repetitively served without specialized equipment, an effort has been made to provide whitened beverage concentrates that can be heated, diluted, cooled, processed and formulated for such applications. However, whitened or creamed beverage concentrate have been challenging to produce due to shelf life and taste. Whitened beverages, unlike many food and beverage concentrates, deteriorate in unacceptable ways due to enzymatic and bacterial degradation that are observed overtime. While such reactions can be retarded through refrigeration and freezing, such storage is expensive and only effective for limited time periods and compromised unless completely utilized at first consumption, inasmuch as the temperature transients in handling outside the refrigerated setting can accelerate and resume the undesired reactions. Such limitations also reduce the availability and increase the cost of such products to the consumer inasmuch as refrigerated shelf space is expensive in storage or retail facilities.

For instance, consumers demand convenience and quality in newly introduced coffee innovations. There are a number of schemes for providing devices for making a single beverage server, such as a cup of coffee or tea. In one approach a disposable container fits on top of a cup and has a compartment for receiving a beverage extract such as coffee with a large reservoir on top into which a person must pour boiling water. U.S. Pat. No. 5,325,765 describes a beverage filter cartridge that includes an impermeable pierceable base having a predetermined shape and an opening at one end; a self-supporting wettable filter element disposed in the base sealingly engages with the opening in the base and has a form different and smaller than the predetermined shape of the base so that the filter element diverges from the base and divides the base into two sealed chambers, a first chamber for storing an extract of the beverage to be made, and a second empty chamber for accessing the beverage after the beverage outflow from the filter has been made by combining a liquid with the extract; and an impermeable pierceable cover sealingly engaged with the opening in the base to form an impermeable cartridge. That disposable container proved to be very popular due to delivering a quality cup of coffee in a convenient manner. However, that approach may not provide an instant cup of whitened beverage because a creamer may need to be added separately reducing the convenience of this approach. Furthermore, if a dry creamer is blended with ground coffee inside the filter element, the hot water extraction of coffee may not be complete resulting in a diluted whitened coffee. Additionally, dry creamer does now produce a quality whitened coffee when compared to a liquid coffee creamer.

One of the approaches in the whitened liquid beverage industry is to freeze the whitened beverage concentrates during or prior to shipping and storage. When needed, the frozen whitened liquid beverage concentrates are left at room temperature for a few days or as needed to thaw out and then should be used immediately otherwise deterioration in quality is noticed and spoilage may occur. Such an approach is expensive and requires freezing capability prior to and during shipping and handling. It also reduces the duration during which the concentrate is suitable for consumption and unused portions often have to be discarded. Aseptic thermal processing of whitened beverage concentrates is one of the approaches used to stabilize beverage concentrates; however, high temperature processing may induce undesirable cooked taste in final beverages. Additionally, the aseptically processed whitened beverage will have to be consumed immediately otherwise it will have to be discarded since the whitened coffee beverage itself is not shelf stable if the packaging container is opened.

In order to achieve a suitable creamed and whitened coffee or tea for example, the consumer has to add milk, cream or creamers in powdered or liquid forms. In recent years, dried, non-dairy coffee whiteners have become of increasing importance in the food industry because of their ability to whiten coffee and their economy, taste, ease of handling and excellent shelf-life. Such dry, non-dairy coffee whiteners are prepared as an emulsion concentrate which is spray dried and, on addition to an aqueous media such as coffee, forms a reconstituted oil-in-water emulsion which whitens and flavors the beverage. Generally, such powdered whiteners comprise, on a dry weight basis, 25%-50% vegetable fat, 35%-65% carbohydrate (such as corn syrup solids, sucrose, etc.), 3%-12% protein, 1%-5% emulsifiers, 0.55-3% stabilizer and stabilizing salts, plus minor amounts of coloring and flavoring agents and anti-caking agents.

In such dry coffee whitener formulations, the vegetable fat or oil, which has a particle size of about 1-3 microns in diameter, provides whitening power, body and viscosity. The whitening effect is produced in coffee or tea primarily as a result of light reflected from the surface of finely emulsified fat globules. The carbohydrate acts as a carrier for the fat to retard coalescence of the fat and provides some sweetness effect. Emulsifiers, such as mono- and diglycerides, diacetyl tartaric acid esters of mono- and diglycerides, propylene glycolmonostearate, lecithin, and the like are incorporated to maintain the fat globules in dispersion.

A majority of non-dairy creamers may also contain a water-soluble carbohydrate such as corn syrup solids, sucrose, lactose, and the like, to provide flavor, improve product body and to act as a carrier for the fat. Generally the dried creamer may contain up to 85% by weight of carbohydrate. Sugars and most carbohydrates could be fermented by microorganism and provide an energy source for growth and subsequently spoilage. Moreover, the inclusion of sugar and carbohydrate may increase the value of Glycemic Index which is important to diabetic individuals and consumer seeking weight control food and beverage.

In order to obtain a dried whitener which provides a stable emulsion upon reconstitution in the coffee and which at the same time is capable of reducing the acidity of the coffee, one or more buffering salts may be mixed with the dried emulsion product. The buffering salt is typically dry blended with the dried emulsion in an amount sufficient to provide a product having a pH of about 5.5 to 7.5 when reconstituted in water. Such a product when added to coffee reduces the acidity of the coffee as seen by an increase in the pH of the coffee to between about 4.5 and 5.0, thereby improving the taste of the coffee. Generally it is preferred to use dipotassium phosphate as the buffering salt to be admixed with the dried fat emulsion product. However other phosphate and citrate salts, such as sodium citrate, tetrasodium pyrophosphate, disodium salts of phosphoric acid, and other food approved buffering salts capable of raising the pH of the dried emulsion may be used. Dipotassium phosphate salt is added in amounts of from 1% to 3%. The use of chemical agents carries a negative connotation to the consumers as being “unnatural”. Therefore, it is desirable to eliminate chemical agents as much as possible.

While the use of protein in the formulation has enabled dried coffee whiteners to be prepared having excellent stability and whitening, it is disadvantageous in some respects. In formulations which contain protein, it is also common to include in the products, stabilizers, such as carageenan, alginates, guar gum, etc., and/or stabilizing or buffering salts, such as sodium citrate, tetrasodium pyrophosphate, etc. to improve the colloidal dispersibility of the protein. The inclusion of these materials, of course, increases the cost of the dried product. Moreover, while sodium caseinate is legally defined to be a non-dairy material, its inclusion in the emulsion makes the product unacceptable to some ethnic groups. Furthermore, some individuals might be allergic to milk casein at very low amounts and may suffer allergic reactions to various degrees. The use of other water dispersible proteins, such as soy protein, has been less than satisfactory due to off-flavors, feathering of the protein in coffee and other problems.

U.S. Pat. No. 4,460,617 is directed to a dry, protein-free coffee whitener comprises a dried emulsion concentrate comprising an edible fat having an average particle size of about 1-3 microns in diameter. The fat is stabilized with a degraded and chemically modified starch derivative. The product is not sugar free though.

U.S. Pat. No. 6,548,101 teaches a stable, whitened coffee concentrate that is a mixture of milk solids, soluble coffee solids, and coffee aroma, that has a solids concentration above about 25% by weight and a process for making the concentrate. The coffee aroma stabilizes the concentrate.

U.S. Pat. No. 4,045,589 discloses that a dried fat emulsion product having excellent stability and coffee whitening characteristics can be prepared without the use of protein by incorporating in the formulation a chemically modified dextrinized starch having a lipophilic character. Such chemically modified starches are effective in maintaining a stable emulsion subsequent to drying of the liquid emulsion concentrate so that protein may be eliminated from the formulation. Thus, a liquid emulsion concentrate containing water, vegetable fat or oil, carbohydrate, emulsifier and the chemically modified dextrinized starch having a lipophilic character is prepared and dried to provide a product which, upon reconstitution by addition to an aqueous media such as coffee or tea, disperses easily in hot liquids with little sign of fat “oiling off” or emulsion instability. The incorporation of starch will provide a product with higher glycemic index that might not be suitable to be consumed by diabetic consumers.

U.S. Pat. No. 6,350,484 pertains to a liquid beverage concentrate which is resistant to microbial growth and contains fructose, non-dairy creamer, a combination of xanthan gum and tragacanth gum, flavorings, and water.

There are several factors that control water activity in a system. Colligative effects of dissolved species (e.g. salt or sugar) interact with water through dipole-dipole, ionic, and hydrogen bonds. Capillary effect where the vapor pressure of water above a curved liquid meniscus is less than that of pure water because of changes in the hydrogen bonding between water molecules. Surface interactions in which water interacts directly with chemical groups on undissolved ingredients (e.g. starches and proteins) through dipole-dipole forces, ionic bonds (H3O+ or OH—), van der Waals forces (hydrophobic bonds), and hydrogen bonds. It is a combination of these three factors in a food product that reduces the energy of the water and thus reduces the relative humidity as compared to pure water. Water activity is temperature dependent. Temperature changes water activity due to changes in water binding, dissociation of water, solubility of solutes in water, or the state of the matrix. Although solubility of solutes can be a controlling factor, control is usually from the state of the matrix.

In the world of whitened beverages like coffee, it is generally found that convenience along with pleasing flavor and aroma are particularly desirable characteristics in such products. If a whitened coffee product lacks a pleasing flavor and aroma, it is often perceived by the consumer to be of lesser quality. What is needed, therefore, is an improved formulation of an instant liquid whitened beverage concentrate which has an extended shelf-life and a resistance to contamination by microorganisms once the packaging container is opened. Additionally, a sugar-free and protein free whitened coffee concentrate that could be blended with hot or cold water and used instantly, maybe highly desirable by certain health conscious consumer.

From the point of view of the consumer, the product offerings currently available have not been entirely satisfactory because no introduction of such a convenient concentrate has taken place. Thus, a well established need continues to exist for a packaged concentrated whitened beverage product having extended storage life at ambient temperatures that retains full flavor without diminution over time and may be added to hot or cold water to produce various beverage formats.

### SUMMARY

The present invention is directed to a technique of producing an instant whitened liquid beverage concentrate that is shelf-stable at ambient temperature without the need for refrigeration or freezing. This invention further relates to a process for manufacturing instant shelf-stable whitened liquid beverage concentrate with enhanced aroma and flavor retention while it contains only traceable amount of sugar, protein and buffering salts.

The processing of the liquid concentrates may not involve any thermal treatment or pasteurization in order to preserve the integrity of flavor and aroma and allow using a reduced serving size. Food grade sugar alcohols and not sugars are added to affect water activity at about or below 0.85 to make the liquid beverage concentrate resistant to microbial growth without the need for additional preservatives, thereby enabling storage at ambient temperatures. Utilizing water activity of about 0.85 or below proved to be sufficient to inhibit the proliferation of pathogens, bacteria, mold and yeast. Further, not adding sugars will deplete the concentrate from fermentable sugars thus eliminating energy source that could be metabolized by spoilage microorganisms.

The ultra-concentrated shelf stable liquid beverage concentrate could be packaged in single-serve or multi-serve kits to deliver a few grams per serving of final beverage.

The present invention further relates to compositions and methods for producing individual dosages or multi-serve packs of instant shelf-stable whitened liquid beverage concentrate to be mixed with water to provide flavored coffee beverages.

It is also an object to provide such a whitener which exhibits relatively less “oiling-off”, if any, and has an improved taste.

In its preferred embodiment, the whitened beverage is protein-free, and may also be emulsifier-free and phosphate-free.

Accordingly, it is an object of the present invention to provide an extended shelf life concentrated beverage product retaining the flavor characteristics of freshly prepared product.

Another object of the invention is to provide a process for packaging instant shelf-stable whitened liquid beverage concentrate like coffee for long term storage under non-refrigerated or non-freezing conditions without a loss of desirable taste and aroma characteristics or any microbial spoilage.

A further object of the invention is to provide instant shelf-stable whitened liquid beverage concentrate to be mixed with water to provide hot or cold beverage without the need of any coffee making or preparing equipment and may be carried out in small packages.

A further object of the invention is produce instant shelf-stable whitened liquid beverage concentrate that is milk casein-free and could be mixed with water to produce cold or hot drinks.

An ideal instant shelf-stable whitened liquid beverage concentrate will have to be stable at room temperature and deliver a cold or hot beverage that is similar to freshly made drinks. A novel process is needed to deliver beverages that avoid of undesirable acidity and bitterness and yet provides the full aroma and flavor of freshly prepared beverage.

Considerable effort, therefore, has been expended in an attempt to address the instant shelf-stable whitened liquid beverage concentrate limitations in the production of high quality beverage products, and the extended use of high quality beverage. There remains a need in the art for compositions and methods for improving whitened shelf stable beverage concentrate to be used with coffee that ensures consistent, stable, high product quality that are easily adaptable to a variety of beverage materials, and are economical and easy to use. Accordingly, it is an object of the present invention to provide compositions and methods which address these needs and provide further related advantages.

Other objects, features and advantages of the present invention will be apparent from these summary and description of preferred embodiments, and will be readily apparent to those skilled in the art having knowledge of gelled products/compositions and their methods of preparation. Such objects, features, benefits and advantages will be apparent from the above as taken in conjunction with the accompanying examples, tables, data and all reasonable inferences to be drawn there from.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

“Shelf stable” means a food product that is microbiologically and chemically stable at ambient temperature without refrigeration or freezing.

“Aseptic processing” means the filling of a commercially sterilized product into pre-sterilized containers, followed by aseptic hermetic sealing, with a pre-sterilized closure, in an atmosphere free of microorganisms.

As used herein, the term “concentrate” means high concentration of beverage solids coupled with elevated levels of beverage whitener.

As used herein, the term “beverage source component” is defined as a blend of beverage sources derived from a natural origin. Depending on the beverage being formulated, there are many species that could be utilized. In case of tea beverages, concentrates, extracts in liquid or dried forms from tea species Camellia sinensis var. sinensis, and Camellia sinensis var. assamica. Blends comprising of black tea, green tea, white tea or oolong tea maybe used. In case of whitened chocolate concentrates, cocoa, cocoa butter or chocolate liquor will be the source. Cocoa bean is the dried and fully fermented fatty seed of Theobroma cacao from which cocoa solids and cocoa butter are extracted. They are the basis of chocolate.

In case of coffee concentrates it is generally recognized by those skilled in the art that there are two primary commercial coffee species, Coffea arabica and Coffea canephora var. robusta. Coffees from the Species arabica are frequently described as “Brazils,” which come from Brazil, or “Other Milds” which are grown in other premium coffee producing countries. Premium arabica countries are generally recognized as including Colombia, Guatemala, Sumatra, Indonesia, Costa Rica, Mexico, United States (Hawaii), El Salvador, Peru, Kenya, Ethiopia and Jamaica. Coffees from the Species canephora var. These robusta coffees are typically grown in the lower regions of West and Central Africa, India, South East Asia, Indonesia, and Brazil.

The beverage source can be in a variety of forms including, but not limited to, liquid concentrates, micro-ground, soluble, spray dried, freeze dried, liquid extracts via aqueous, super-critical fluid, and organic solvent extraction processes. The source can also be caffeinated, decaffeinated, or a blend of both.

As used herein, the term “coffee concentrate” means a liquid coffee extract, or a dried product of the extract, obtained by aqueous extraction of roasted and ground coffee, wherein such extract may require further processing (e.g., dilution) prior to consumption.

As used herein, the term “coffee extract” means a liquid extract of roasted and ground coffee, or a dried product of the extract, obtained during the manufacture of soluble (i.e., instant) coffee. Additionally, the term “coffee extract” refers to an “intermediate” liquid or solid that is subsequently processed and eventually dried to provide soluble (instant) coffee particles.

As used herein, the term “soluble coffee product” means a coffee product comprising soluble, or instant, coffee particles which can be prepared by any process known to those skilled in the art, as well as by the process described herein. In general, soluble coffee is prepared by roasting and grinding a blend of coffee beans, extracting the roasted and ground coffee with water to form an aqueous coffee extract, and drying the extract to form the “soluble coffee product.”

“Fat source component” used herein means a triglyceride product that provide triglycerides physical characteristics to beverage concentrates and provide substantially fatty material to whiten the concentrate. Fats and oils which may be used include anhydrous milk fat, butter, cream, cocoa butter, partially or fully hydrogenated vegetable fats and oils, such as, for example, cottonseed oil, coconut oil, corn oil, soybean oil, peanut oil, sunflower oil, palm kernel oil, and the like, and mixtures thereof, tallow and lard. Medium chain fatty acids or enzyme modified fat may also be utilized in the current invention.

“Polyols source component” used herein means a sugar alcohols. Example of such material is glycerin, maltitol, sorbitol, xylitol, and mannitol, isomalt, hydrogenated starch hydrolysate, lactitol and erythritol.

The term “water activity level” is defined in the book “Food Science”, Third Edition, A.V.I. (1984) as a qualitative measure of unbound free water in a system that is available to support biological and chemical reactions. In general, as the water activity of a given food product decreases, its shelf life increases. A high water activity (Aw) product becomes more susceptible to mold, fungus and bacterial proliferation. For instance, the FDA defines a low acid food product with a pH of greater than 4.6 as shelf stable only if it has a water activity of 0.85 or less. Two foods with the same water content can vary significantly in their water activity depending on how much free water is in the system. When a food is in moisture equilibrium with its environment, the water activity of the food will be quantitatively equal to the relative humidity in headspace of the container divided by 100.

As used herein the term “free” means substantially void of a chemical compound and may contain only a small traceable amount of that “chemical compound”. Nutritional labeling in the United States of America allows the word “free” to be used if a given nutrient or component is present at less than about 0.50%. Accordingly, “protein-free, sugar-free” means that the product contains less than 0.5% of protein or sugar.

As used herein the term “homogenized” is used interchangeably with the term “homogenization” to mean the preparation of an oil-in-water emulsion of the type described herein. The oil droplets have a defined particle size and particle size distribution. An emulsion may be homogenized by any method known to one skilled in the art, such as, for example, subjecting the emulsion to high temperature and/or high pressure and/or multiple pass homogenization and/or high sheer or combinations thereof.

The “glycemic index”, glycaemic index, or GI is a measure of the effects of carbohydrates on blood sugar levels. The GI concept has been developed to characterize food behavior during human digestion. The glycemic index of a food is defined as the area under the two hour blood glucose response curve following the ingestion of a fixed portion of carbohydrate (usually 50 g). The current validated methods use glucose as the reference food, giving it a glycemic index value of 100 by definition. Low GI food has range of 55 or less, medium GI food has a range of 56-69 and high GI food has a range of 70 and above.

Carbohydrates that break down quickly during digestion and release glucose rapidly into the bloodstream have a high GI; carbohydrates that break down more slowly, releasing glucose more gradually into the bloodstream, have a low GI. A lower glycemic index suggests slower rates of digestion and absorption of the foods' carbohydrates and may also indicate greater extraction from the liver and periphery of the products of carbohydrate digestion. A lower glycemic response usually equates to a lower insulin demand, and may improve long-term blood glucose control and blood lipids. A low GI food is desirable to be consumed by diabetic individuals. Several lines of recent scientific evidence have shown that individuals who followed a low-GI diet over many years were at a significantly lower risk for developing both type 2 diabetes and coronary heart disease than others. High blood glucose levels or repeated glycemic “spikes” following a meal may promote these diseases by increasing oxidative stress to the vasculature and also by the direct increase in insulin levels. Recent animal research provides compelling evidence that high-GI carbohydrate is associated with increased risk of obesity.

### DETAILED DESCRIPTION OF THE INVENTION

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing the subject components of the invention that are described in the publications, which components might be used in connection with the presently described invention.

The information provided below is not admitted to be prior art to the present invention, but is provided solely to assist the understanding of the reader.

The details of one or more embodiments of the invention are set forth in the accompanying drawings and the description below. Other features, objects, and advantages of the invention will be apparent from the description and drawings, and from the claims.

The present invention relates to novel method for producing an instant shelf-stable whitened liquid beverage concentrate. More specifically, the present invention is directed to a technique of stabilizing an ultra-concentrated liquid creamed beverage to make it shelf-stable at room temperature without the need for refrigeration or freezing.

This invention further describes a process for manufacturing ultra-concentrated stabilized liquid creamed beverage with enhanced aroma and flavor without perceived acidity or bitterness. The concentrated liquid beverage concentrate is also resistant to microbial growth without the need for refrigeration, freezing or additional preservatives, thereby enabling storage at ambient temperatures. The creamed or whitened concentrate of the current invention is protein-free and fermentable sugar-free.

In order to prepare liquid stabilized beverage, the standard practice in the industry is to subject the liquids to thermal heat treatments. Sterilization, aseptic packaging or pasteurization alter the flavor characteristics of liquid beverage and produce off-notes. The methods of the prior art to stabilize the liquid beverage concentrates utilize elevated temperatures that are selected to thermally destroy microorganisms, can easily evaporate or destroy flavor compounds in liquid coffee. Upon exposure to excessive temperatures long thermal treatment times acid concentration may increase as well. Beverage concentrates maybe exposed to elevated temperatures between about 285° F. to about 295° F. After heating, concentrates are processed through an aseptic system to a packaging line. The concentrates may be exposed to a single or multistage heating configuration. In one approach, the concentrate is exposed to an aseptic heating coil at temperatures of about 293 to about 295° F. Furthermore, in another approach, the heating may be a first heater of about 179° F.; a second heater of about 285° F. to about 295° F., and a third heating stage of about 293° F. to about 295° F. temperatures above these ranges tend to flash off or destroy the functionality of the flavor and generally tend to degrade the flavor of the coffee. Temperatures below this range are not practical because they require longer processing equipment and longer processing times. When whitened beverage concentrates are produced, usually a source of dairy protein and sugar is included along with a fat source. It is essential to add buffering and/or stabilizing salts to stabilize the included fat and protein during processing. In addition, the added sugar tends to stabilize the fat emulsion and provide a sweet background taste.

The inventors have discovered that components of whitened beverage concentrate can be blended at room temperature without using any thermal processing or, alternatively, minimally heat treated to temperatures about 160-190 F. That approach helps in preserving the aroma and flavor of combined beverage whitened component. Furthermore, the inventive process eliminates the need for buffering and/or stabilizing salts. Additionally, the low temperature processing of various whitened beverage concentrate ingredients eliminates the need to add any fermentable sugar or any type of protein to stabilize the emulsion.

When whitened coffee beverage concentrate components are heated to about 160-170 F, cooled to ambient temperature, and then microground coffee is added, aroma and flavor that are carried by liquid concentrates are preserved inside the ultra liquid concentrate and released only when the inventive concentrate is added to hot water. By this novel mean, the aroma and flavor are kept protected until the product is finally used by consumers. Microground coffee has a particle size of about 20 to 350 micron. Suitable reduced-size coffee forms could be from coffee beans that have been microground, micronized, pulverized or finely ground.

The starting beverage source component may be formed as an extract, concentrated liquids, reconstituted beverage, soluble or an instant beverage, with or without water. By one approach, a suitable beverage source component may have between about 20 and about 60 percent solids and, preferably, about 30 and about 55 percent solids, and most preferably, between about 40 percent and 60 percent solids. Beverage source component may be obtained from blending various components at room temperatures to yield about 70 percent beverage extracts. Preferred starting liquid concentrates and extracts generally have an initial pH ranging from about 4.7 to about 5.5. The desired organoleptic qualities of taste, flavor, and aroma should remain relatively consistent by adjusting percentage of various beverage source components to produce various flavor profiles.

The current invention allows for reducing the caloric content of final beverage because of the avoidance of metabolized sugar in the inventive method. Food energy is the amount of energy obtained from food that is available through cellular respiration. In USA, food energy is expressed in food calories. Food calories, or the “calorie” units used often in nutritional contexts, measure amounts of energy 1000 times greater than the units in scientific contexts known also as calories, or gram calories. It is highly recommended by nutritionist to reduce the caloric intake in order to avoid obesity and other health related complications. Beverage, in general, constitute a large portion of daily caloric intake.

In addition, low GI and low calorie beverages could be produced using the current invention. Historically nutritionists have classified carbohydrates as either simple or complex. Simple carbohydrate typically refers to monosaccharides, disaccharides and complex carbohydrate (polysaccharides). Some nutritionists use complex carbohydrate to refer to any sort of digestible saccharide present in a whole food. Some simple carbohydrates (e.g. fructose) are digested very slowly, while some complex carbohydrates (starches), especially if processed, raise blood sugar rapidly.

The inventive composition does not incorporate any sugar or carbohydrate; rather the present compositions utilize sugar alcohols or polyols. As a group, sugar alcohols are not as sweet as sucrose, and they have less food energy than sucrose. Their flavor is like sucrose, and they can be used to mask the unpleasant aftertaste of some high intensity sweeteners. Sugar alcohols are not metabolized by oral bacteria, and so they do not contribute to tooth decay. They do not brown or caramelize when heated. For instance, glycerin cannot be metabolized or fermented by microorganisms as an energy source, making it ideal for shelf stable products. Furthermore, sugar alcohols have the ability to lower the water content of concentrated whitened coffee to levels that are not favorable to bacteria, mold and yeast, thus extending shelf life.

Sugar alcohols are usually incompletely absorbed into the blood stream from the small intestines which generally results in a smaller change in blood sugar than “regular” sugar sucrose. This property makes them popular sweeteners among diabetics and people on low carbohydrate diets. However, like many other incompletely digestible substances, over consumption of sugar alcohols can lead to bloating and diarrhea because they are not absorbed in the small intestine.

When used as a food additive, the sugar alcohols (polyols) have the effect of reducing the water activity of liquids. Suitable materials for use are those liquids and fluids with minimal amount of water (about 30% or less) and remain flowable at around 80 to 110 F. Example of such material is glycerin (about less than 1% water, liquid at room temperature, viscous, stable, hygroscopic, clear, odorless, noncorrosive, and sweet tasting), maltitol, sorbitol, xylitol, and mannitol, isomalt, hydrogenated starch hydrolysate, lactitol and erythritol.

Use of a sugar alcohol in place of carbohydrate sweeteners allows for both lowered water activity and lowered sweetness in addition to lowered viscosity. The most preferred sugar alcohol is glycerin. Based on weight, the sugar alcohol preferably comprises about 10 to about 48% of the liquid whitened beverage concentrate, more preferably about 15 to about 30%, and most preferably about 25%.

While not wishing to be limited by theory, it is believed that the addition of glycerin allows for the elimination of pasteurization of other thermal processing, thus helping in attaining excellent aroma in the finished beverage. Never the less, the added glycerin may accentuate the fine taste of whitened coffee.

The current discovery is contradictory to the prior art. Typically, for liquid creamed beverage concentrates a thermal treatment at high temperature is required to destroy microorganisms, followed by aseptic packaging. The concentrate will have to be used immediately or get refrigerated otherwise spoilage may occur. The current discovery permits the concentrate to be left exposed to air at ambient temperature after opening the package without supporting microbial spoilage. It is preferred to add polyols to achieve a pH of about 0.85 or less. The liquid beverage concentrate has lowered water activity, which is necessary for effective preservation from microbial growth. Common pathogenic bacteria do not effectively propagate in media with a water activity of less than 0.83. The majority of particularly hazardous bacteria cannot effectively propagate in media with water activity of 0.85 or less.

In a preferred embodiment, the concentrate comprises 10-50% (preferably 15-45%) by weight of the edible fat source component and most preferably about 22%. Although it is generally not required, the concentrate may contain up to 3.0% by weight of a fat emulsifier. The edible fat has an average particle size of about 1-2 microns in diameter, and the starch derivative to fat ratio is in the range of 0.1 to 0.2 microns.

The inventor of the present invention has surprisingly discovered that the inclusion of a step to enhance flavor and aroma of concentrates whereby the fat source has a droplet size of from about 0.1 micron to about 25 microns has resulted in significant improvement as to both flavor and aroma. In another embodiment, the present invention teaches the method of producing an ultra-concentrated whitened coffee product having improved whitening when the Fat source does not have any droplet size requirement, yet after homogenization, the whitened concentrate has a droplet size of from about 0.1 micron to about 15 microns when reconstituted as a beverage and wherein the whitened coffee product is free of added protein, sugars and buffering agents. Furthermore, the employment of a homogenizer enables the concentrate to utilize a much lower fat ratio and creates a stable emulsion in both the concentrate and final beverage. In addition, whitened coffee concentrates made with homogenized fat droplets of size of from about 0.1 microns to about 15 microns show no appreciable signs of fat “oiling off” or emulsion instability when added to coffee, counteract coffee's bitter notes, and afford improved taste. The emulsified oil droplet size of the present invention may be measured with a Horiba LA-910 Particle Size Distribution Analyzer (Horiba Instruments, Inc., Irvine, Calif.).

A wide variety of edible fats or oils may be used in the present invention. The fat or oil may be of animal or vegetable source, but should have a bland or neutral flavor and long term stability towards oxidation and the development of rancidity. Moreover, in formulating dried coffee whiteners it is generally preferred to use fats with a melting point of about 38° C.-46° C. (110° F.-115° F.) so that a major portion of its triglycerides will remain in a solid state at the maximum temperatures usually encountered in handling, shipping and storage of the product. Fats and oils which may be used include partially or fully hydrogenated vegetable fats and oils, such as, for example, cottonseed oil, coconut oil, corn oil, soybean oil, peanut oil, sunflower oil, palm kernel oil, and the like, tallow, lard and milk fat; and mixtures thereof.

While the product of the present invention may be prepared without using any external emulsifier, an emulsifier may be included in the liquid emulsion concentrate to increase the ease of formation of the emulsion and to promote the stability of the liquid emulsion concentrate to be dried. Emulsifiers which may be used are those which are approved for use in foods, such as mono- and diglycerides, distilled monoglycerides, glycerol mono-stearates, sorbitan esters of hexitol anhydrides, polyoxyethylene sorbitan esters of hexitol anhydrides, and combinations of such food approved emulsifiers. The amount of emulsifier used, if any, is up to 3.0% by weight of the solids used in the emulsion concentrate, preferably only up to 1%.

As noted hereinabove, the elimination of proteins and fermentable sugars helps provide a low flow viscosity enabling an easy dispersion into packs and into reconstitution water. Elimination of such ingredients in the emulsion concentrate does not impact the stability of the emulsion when the product is added to water. Never the less, a stable emulsion is formed which has a whitening effect equal or superior to conventional sugar and/or protein-containing whitened coffee.

Any conventional flavorings are suitable for use in the concentrate. Flavorings can be used individually or in combination. Preferred flavorings include coffee, cappuccino, tea, cocoa, fruit juice, spices and chocolate. For each flavoring independently, based on weight, the flavoring preferably comprises about 0.1 to about 3.0% of the liquid beverage concentrate. A preferred total flavoring concentration, based on weight, is about 0.4 to about 20% of the liquid beverage concentrate, and preferably about 2.5 to about 8%. Other optional ingredients include pH modifiers such as acidifiers, neutralizers, preservatives, colorings, and emulsifiers. Acidifiers that can be used in the liquid beverage concentrate include acids such as lactic acid. Neutralizers such as sodium or potassium hydroxide may be used as well. Preservatives are added to enhance the shelf-life of the liquid beverage concentrate. The liquid whitened beverage concentrate itself is resistant to microbial growth without the addition of extra preservatives and can be stored at ambient temperatures without refrigeration. Preferred preservatives include potassium sorbate. Any conventional food colorings can be used; the limitations on the additions of all of these optional components are variable dependent on their final effect on taste, mouth feel, and viscosity. Example of non-nutritive sweeteners includes Sucralose, Aspartame, Saccharin, Stevia and other high potency sweeteners. Moreover, the present improved ultra-concentrated liquid whitened coffee may comprise from about 0.5% to about 6.0%, preferably from about 1.0% to about 3.0%, and more preferably from about 0.75% to about 1%, coffee oil or cocoa butter, by weight of the final soluble coffee product. Additionally, the coffee oil or cocoa butter has a droplet size of from about 0.1 to about 25 micron, preferably from about 0.1 to about 20 micron, more preferably from about 0.1 to about 15 micron, and still more preferably from about 1 to about 10 micron when the product is reconstituted as a final beverage. Preferably, the overall viscosity of the liquid beverage concentrate should remain sufficiently low to enable the use of conventional beverage pumps and dispensers. Any additional additives should not adversely affect the taste and mouth feel of the final beverage product.

As stated above, the pH of the whitened beverage concentrate may be adjusted with an acid or alkaline, if necessary, in an amount sufficient to provide the emulsion with the pH about 4.5 to 6.5, yet preferably the pH is at least 5.0.

To provide a ready to serve liquid beverage from the liquid creamed concentrate, the concentrate is mixed with water or carbonated water to obtain a homogeneous dilution of the concentrate. Mixing can be accomplished by any conventional means known in the industry. These means include conventional soda fountains, “bag-in-a-box” type beverage concentrate mixing and dispensing machines, blenders, soft serve ice cream machines, and “slush” machines. In a preferred example, the final beverage product is formulated by mixing the concentrate with between about one and about twenty volumes of water. Lower concentrations of the concentrate are acceptable, resulting in the need for less water.

An advantage of the liquid beverage concentrate is that it can be stored at ambient temperatures without refrigeration and without additional preservatives and is still resistant to microbial growth and still substantially maintains its sensory taste after 3, 6, 9, 12 or more months.

The instant shelf-stable whitened liquid beverage concentrate is then filled into suitable containers, without thermal treatment like retort or heating prior to filling. Containers suitable for containing the instant shelf-stable whitened liquid beverage concentrate of the invention can be flexible, semi-rigid or rigid depending upon the process conditions and the type of product desired. Suitable containers include, but are not limited to, stick packs; sachets; carton-based; tetrahedron packs (closeable or not); Unifill packs; squeezable plastic bottles; stand up pouches; multi-serve bottles, portable bottles, plastic cups; and the like. The containers should be such that they provide a barrier to minimize exposure of the whitened coffee concentrate to water vapor, oxygen, and light transmission. A sufficiently high barrier can be obtained, for example, with a container made of a film that contains polyester/aluminum/polyethylene layers.

In one embodiment the instant shelf-stable whitened liquid beverage concentrate is packaged in single serving containers. For single serving containers, the container is suitably a sachet or stick pack. By stick pack is meant a long, narrow sachet. Equipment and material for producing these containers are commercially available. Vertical form fill and seal machines may be used. Conveniently, the sachet or stick pack has a tear off section which may be provided in the usual manner by a notch, fancy cut, or laser cut. Presenting the instant shelf-stable whitened liquid beverage concentrate in this form offers the advantage that the concentrate may be provided in a convenient, single serving pack. The consumer then need only open the pack, pour or squeeze the concentrate into a cup, and add water. Typically, the stick pack contains between about 5 g and 10 g of the concentrate.

In another embodiment the instant shelf-stable whitened liquid beverage concentrate is packaged in plastic containers and sealed with foil lid. Standard and commercially available polystyrene cups with various barriers and liners may be filled with the instant shelf-stable whitened liquid coffee concentrate is packaged as single serving containers to used with commercial coffee serving machines. One widely used single serve coffee machine is Keurig Single Serve brewing system coffee machine. The plastic container holds about 29-31 grams of a food product. In such a case, it will be a challenge to fill only 5-15 grams of concentrated shelf-stable creamed liquid beverage. In order to overcome the difference in fill volume as a result of using the inventive concentrated shelf-stable liquid coffee, the liquid coffee will have to be thickened up to prevent leaking out of plastic cup when placed into a coffee machine. It is also recommended to purge inert gas into the plastic cup to preserve the integrity of flavor and aroma of concentrated shelf-stable liquid beverage inside the cup. The present gelling agents may be selected from all or at least a portion of the gelling agent is supplied by a member from the group consisting of collagen (gelatin), gellan gum, carbohydrate gel forming polymers (such as pectin), agar, carageenan and alginates. Other thickening agents may include but not be limited to guar, Xanthan, Caribbean gums, Carboxymethyl cellulose and gel forming starches and carbohydrates. Gelling agent that forms an irreversible gel may also be utilized. The particular gelling agent(s) usage level depends upon a variety of factors such as the desired textural properties in the finished product, total solids level and type, and strength of the gelling agents. Generally, however, good results are obtained when the total gelling agent is present at levels ranging from about 1% to 10%.

Beverages produced from the instant shelf-stable whitened liquid beverage concentrate have a good aroma and flavor profile without harsh acidity. In addition, the instant shelf-stable whitened liquid beverage concentrate of the invention has good stability and may be stored for extended periods at room temperature.

The whitened concentrate is also suitable for use as a coffee whitener should, upon addition to coffee, not only whiten the coffee but also reduce somewhat the bitter notes or acidity of the coffee, provides a stable emulsion upon reconstitution in the coffee and which at the same time is capable of reducing the acidic taste of the coffee.

Turning to more of the details, beverage source component, polyols component, fat source and other optional ingredients may be combined in a standard food mixing and processing vessel in any order of addition. No heating is required for blending. The most important factor to be observed is to bring the water activity of the mix to about 0.85 or below. A range of water activity of about 0.60 and 0.85 would be suitable, preferably about 0.73 to 0.83.

The fat source component can be blended with fat emulsifiers and fat soluble flavors, and then heated to suitable melting point of fat source in an agitated tank in order to disperse the oil, thereby creating a pre-emulsion.

The above ingredients and components may be added using either a batch or continuous process system. If a thermal heating step is to be included, the heating may take place at any phase or step of the mixing process without any significant impact on the final product. Once ingredients are added and blended, the concentrate is then pumped to a two-stage homogenizer, such as a lab homogenizer or Gaulin M3 (APV-Gaulin Co., Everett, Mass.) equipped with a standard valve and homogenized at about 3,000 to 5,000 psig with the second stage comprising about 10% of the total pressure. The resulting homogenized liquid beverage concentrate extract is ready for optional further processing.

The temperature of the emulsion ranges from about ambient to about 150.degree. F. preferably around about 100.degree. F. In general, the temperature of the emulsion should be controlled precisely to ensure that volatile flavor and aroma component will be retained and no heat induced off-notes are developed.

Acidity modifiers and other optional flavors and ingredients may be added at any stage. Any of processing vessels may be used to produce the concentrate.

When ground coffee (particle size of about 350 microns or less) is optionally incorporated in the liquid concentrate at room temperature, the ground coffee does not release coffee taste or aroma and stays inert until the addition of hot water for final consumption. That novel approach helps to enhance aroma, reduce acidity perception and increase overall quality of whitened coffee beverages.

Any sequence of ingredients addition may be adopted before the incorporation of components and ingredients. In one embodiment, coffee source component is added first to the processor. Next glycerin and then fat source are added with continuous agitation. Modification of pH is then performed to attain a pH of about 5.0 to 5.5.

The instant shelf-stable whitened liquid beverage concentrate is then filled into suitable containers, without thermal treatment like retort or heating prior to filling. Containers suitable for containing the instant shelf-stable whitened liquid beverage concentrate of the invention can be flexible, semi-rigid. Suitable containers include, but are not limited to, stick packs; sachets; carton-based; tetrahedron packs (closeable or not); Unifill packs; squeezable plastic bottles; stand up pouches; multi-serve bottles, portable bottles, plastic cups; and the like.

Beverages produced from the instant shelf-stable whitened liquid beverage concentrates have a good aroma and flavor profile without harsh acidity. In addition, the instant shelf-stable whitened liquid beverage concentrate of the invention has good stability and may be stored and distributed either at room temperature, refrigerated or frozen depending on the type of requirement of distribution channels and the end-user.

Advantages and embodiments of the methods described herein are further illustrated by the following examples; however, the particular conditions, processing schemes, materials, and amounts thereof recited in these examples, as well as other conditions and details, should not be construed to unduly limit this method. All percentages are by weight unless otherwise indicated.

### EXAMPLES

### Example 1

Whitened coffee concentrates were formed and evaluated in hot water. One thousand grams of the components mentioned below were blended in a Hobart mixer to make various combinations. After blending, components were transferred to double wall heating stainless steel containers, heated to about 130-135 F with agitation. When all components were mixed thoroughly well, each combination was homogenized in a lab homogenizer at about 3,000 psi with the second stage comprising about 500 psi to achieve fat droplet size of about 0.1 to 3 microns in final concentrate.

The emulsions were formulated as follows:

| | A | B | C | D | E |
|---|---|---|---|---|---|
| Ingredient | % | % | % | % | % |
| Liquid Coffee Concentrates | 48.30 | 43.30 | 32.00 | 9.00 | 32.90 |
| Glycerin | 10.00 | 20.00 | 40.00 | 50.00 | 60.00 |
| Maltitol | 10.00 | 5.00 | | | |
| Soluble Coffee | 10.00 | 10.00 | 5.00 | 30.00 | 0.00 |
| Palm Oil | 20.00 | 20.00 | 20.00 | 10.00 | 5.00 |
| Mono & Diglycerides | 0.20 | 0.20 | | | 0.10 |
| Polysorbate 60 | 0.50 | 0.50 | 1.00 | 1.00 | 2.00 |
| Coffee Essence | 1.00 | 1.00 | 2.00 | 0.00 | 0.00 |

Resultant whitened coffee concentrates were packaged in laminated foil pouches (15 and 25 grams each), and sealed. Water activity of various combinations ranged between 0.88 and 0.55. When the content of each pouch was added to about 400 gram hot water, the organoleptic characteristics of the hot beverage were excellent.

### Example 2

A shelf stable creamed coffee concentrates that are casein-free, sugar-free were formed and evaluated in hot water. Fat source (Coconut Oil, coffee oil, Anhydrous Milk Fat) was blended with Polysorbate 60, and heated to about—160-190 F, all ingredients except microground coffee were incorporated, then homogenized in a lab homogenizer at about 6,000 psi with the second stage comprising about 600 psi for about three cycles. Other ingredients were added, blended to a homogenous liquid mix. After cooling to about 80-120 F, microground coffee was added. One thousand grams of the various combinations were made.

| | F | G | H | I | J |
|---|---|---|---|---|---|
| Ingredient | % | % | % | % | % |
| Liquid Coffee Concentrates | 44.90 | 32.00 | 43.50 | 39.00 | 52.90 |
| Glycerin | 15.00 | 25.00 | 25.00 | 30.00 | 30.00 |
| Microground Coffee | | 5.00 | | 9.00 | |
| Soluble Coffee | 20.00 | 10.00 | 5.00 | 10.00 | 10.00 |
| Coconut Oil | 10.00 | 20.00 | 20.00 | 10.00 | 5.00 |
| Coffee Oil | | 1.00 | 1.50 | | |
| Anhydrous Milk Fat | 10.00 | 5.00 | | | 0.10 |
| Coffee Flavors | | | 2.00 | 1.00 | |
| Polysorbate 60 | | 1.00 | 1.00 | 1.00 | 2.00 |
| Coffee Essence | 0.10 | 1.00 | 2.00 | | |

Resultant creamed coffee concentrates were packaged in plastic cups at about 15 grams each, and sealed with foil lids. Furthermore, the same combinations were prepared with the addition of about 0.15% xanthan gum to thicken up the liquids to reduce any dripping out of the cup when brewed in instant coffee machines.

The solids content of various combinations ranged between about 45.0 and 73.00%. Water activity had the range of 0.86 to 0.65. Plastic cups were placed inside an instant coffee maker and brewed. Beverages had acceptable taste, aroma, color and flavor.

### Example 3

Instant low GI and reduced calorie flavored whitened coffee concentrates that are free from protein, buffering salts and fermentable sugars were produced and evaluated in both hot and iced water. One thousand grams of each flavored coffee concentrates below were formed at about 90 to 100 F and homogenized at about 11,000 psi with the second stage comprising about 1000 psi to produce small fat particle size of about 0.1 to 2.0 microns.

| | Sweetened | French | | Iced |
|---|---|---|---|---|
| | Latte | Vanilla | Mocha | Coffee |
| Ingredient | % | % | % | % |
| Liquid Coffee Concentrates | 46.95 | 33.85 | 37.80 | 47.00 |
| Glycerin | 22.00 | 22.00 | 22.00 | 21.00 |
| Soluble Coffee | 10.00 | 20.00 | 17.00 | 10.00 |
| Palm Oil | 20.00 | 20.00 | 15.00 | 20.00 |
| Mocha Flavor | | | 3.00 | |
| Chocolate Flavor | | | 3.00 | |
| French Vanilla Flavor | | 3.00 | | |
| Cocoa | | | | |
| Lecithin | 0.90 | 1.00 | 2.00 | 2.00 |
| Sucralose | 0.15 | 0.15 | 0.20 | |

Resultant whitened coffee concentrates were packaged in squeezable bottles (about 50 grams each). Sweetened flavored drinks were prepared by mixing about 10 grams of the concentrates with 180 ml either hot or cold water. Organoleptic evaluation of various beverages elucidated the capability of the current discovery to produce convenient, portable and delicious hot and cold beverages that do not contain high calorie and have a low GI. Caloric content ranged between 20 and 30 calories per serving.

### Example 4

Several popular flavors of shelf stable whitened drink concentrates were produced using the inventive process. The concentrates did not include any coffee component, rather other popular tea or chocolate components. The concentrates were mixed according to the teachings of example one and packaged in bulk pack to mimic food service containers that could be used with commercial dispensing machines. The following describes the combination of ingredients:

| | Green Tea | Chai | Tea | Chocolate |
|---|---|---|---|---|
| Ingredient | % | % | % | % |
| Liquid Tea Concentrates | 27.10 | 56.20 | 42.00 | 24.00 |
| Glycerin | 22.00 | 23.00 | 32.80 | 32.80 |
| Green Tea Extract | 30.00 | | | |
| Palm Oil | 20.00 | 20.00 | 23.00 | 41.00 |
| Lecithin | 0.90 | 0.30 | 2.00 | 2.00 |
| Spices | | 0.30 | | |
| Stevia | | 0.20 | 0.20 | 0.20 |

Excellent creamed concentrates were obtained as evident by the evaluation of each combination when added to water. The emulsions showed good stability with no apparent oiling off or textural defects. The example elucidate the capability of the current invention to produce other than creamed coffee concentrates that are shelf stable, contain low GI and has not protein or buffering salts.

### Example 5

The ability of the instant shelf-stable whitened liquid beverage concentrate to inhibit the proliferation of various bacteria was studied. The liquid coffee concentrates G of example 2 were submitted for a challenge test. The products were challenged against the bacteria E. coli 0157:H7 (chosen because it represents a serious health concerns in the fields of food industry and medical care organizations). The goal of was to determine if the product was able to reduce the level of the organism by a log factor of five within three days. A culture of E. coli 0157:H7 (ATCC#700728) was grown and inoculated into 100 grams of the test product. Samples were left at room temperature (approximately 72 F), and tested once a day for four days, using Plate Count Agar. The initial inoculation level was 61,000,000 cfu/g. sample (6.1×10̂7). The goal of the test was to determine how the organism would react to the product. The limit for passing this test was set at a reduction of at least five logs from the inoculation level within 3 days of the inoculation. The results were as follows:

### Initial Count:

Aerobic Plate Count<10 cfu/g

### Day 1:

Aerobic Plate Count<10 cfu/g

### Day 4:

Aerobic Plate Count<10 cfu/g

Initial testing demonstrated no presence of significant initial amounts of coliform, or E. coli prior to inoculation which might interfere with the test. One-day results indicated that the concentrates were able to reduce the level of the inoculated organism to below the lower limits of the test, <10 cfu/gm. Each follow up test at days 2-4 yielded the same result of <10 cfu/gm. The results from the tests show a reduction greater than six logs. The products passed the tests and indicated that other pathogenic and spoilage microorganisms will be expected to be inhibited and it would also be expected to show concentration count reduction in the manner observed with the tested E. coli.

### Example 6

The ability of the instant shelf-stable liquid coffee concentrates to inhibit the proliferation of various mold and yeasts was studied. The liquid coffee concentrates G of example 2 were submitted for challenge tests. The test samples were inoculated with approximately 100,000 per gram of sample with Aspergillus niger or Hanseniaspora uvarum. The goal of the tests was to determine how each organism would react to the product. Passing, or failing this stress test was determined by the growth, or death rate of the organisms, along with the organisms' ability to maintain viability (survive) in the product. Initial test of the samples to be used showed no significant presence of any of the test organisms. Seven-day results indicated that the sample was able to inhibit the growth of all of the inoculated organisms. It significantly decreased the inoculated levels of each of the organisms. Results for subsequent testing remained at or about <10. While there was a count in the thousands for both the Lactobacillus buchneri and Hanseniaspora uvarum organisms at 7 days, these counts still represented over a 95% reduction from the inoculation level 7 days earlier. Additionally the organism was completely eliminated by day 21. These concentrates passed the stress tests. These results, also demonstrate that the coffee concentrates of the present invention have the ability to inhibit growth of these organisms. Furthermore, the tests demonstrate that the coffee concentrates will quickly and effectively decrease significant amounts of these organisms if they find their way into the products during production or after they have been opened.

1. A shelf stable liquid whitened beverage concentrate comprising a polyol source component, a fat source component and a beverage source component.

2. The liquid whitened beverage concentrate of claim 1, wherein, based on the total weight percentage of the liquid beverage concentrate, the polyols source component is present from about 20 to about 60%, the fat source component is present from about 5 to about 40% and beverage source component is present from about 25 to about 65%.

3. The liquid whitened beverage concentrate of claim 1, wherein the polyols source component is glycerin, maltitol, sorbitol, xylitol, and mannitol, isomalt, lactitol and erythritol, or mixtures thereof.

4. The liquid whitened beverage concentrate of claim 1, wherein the fat source component is anhydrous milk fat, butter, cream, tallow, lard, partially or fully hydrogenated vegetable fats and oils including cottonseed oil, coconut oil, corn oil, soybean oil, peanut oil, sunflower oil, and palm kernel oil, medium chain fatty acid triglycerides or mixtures thereof.

5. The liquid whitened beverage concentrate of claim 1, wherein the beverage source component is a microground coffee, dry or liquid coffee extract or concentrate, of the species of Coffea arabica and/or Coffea canephora var. robusta, or mixtures thereof.

6. The liquid whitened beverage concentrate of claim 1, wherein the beverage source component is from tea species Camellia sinensis var. sinensis or Camellia sinensis var. assamica as a dry or liquid tea extract, concentrate, soluble comprising of black tea, green tea, white tea, and oolong tea, or mixtures thereof.

7. The liquid whitened beverage concentrate of claim 1, wherein the beverage source component is a dry or liquid chocolate extract, concentrate of species of Theobroma cacao plant, or mixtures thereof.

8. The liquid whitened beverage concentrate of claim 1, wherein the water activity is about 0.85 or less.

9. The liquid whitened beverage concentrate of claim 1, wherein the concentrate further comprising one or more flavorings, acidulants, neutralizers, colorings, preservatives, and fat emulsifying agents.

10. The liquid whitened beverage concentrate of claim 1, wherein the concentrate further produce low glycemic index of about 55 or less when prepared for consumption.

11. The liquid whitened beverage concentrate of claim 10, wherein the concentrate is suitable for consumption by diabetic individuals.

12. The liquid whitened beverage concentrate of claim 1, wherein the concentrate has a caloric content of 20 to 30 calories.

13. A shelf stable liquid creamed beverage concentrate comprising a polyols source component, a fat source component and a beverage source component.

14. The liquid creamed beverage concentrate of claim 13, wherein the concentrate is free from milk casein, proteins, or mixtures thereof.

15. The liquid creamed beverage concentrate of claim 13, wherein the concentrate is free from fermentable sugar, metabolizable sugar, or mixtures thereof.

16. The liquid creamed beverage concentrate of claim 13, wherein the concentrate is free from buffering salts and buffering agents, or mixtures thereof.

17. The liquid creamed beverage concentrate of claim 13, wherein the concentrate contains fat droplet size from about 0.1 to 25 microns.

18. A process of forming an instant shelf-stable whitened beverage coffee concentrate comprising:
a—mixing a polyols source component, a fat source component and a beverage source component;
b—stirring the mixture until homogeneous liquid is obtained;
c—adjusting water activity of the homogeneous mixture to about 0.85 or less
d—homogenizing the mixture a second time, and
e—packaging the resulting concentrate in a hermetically sealed container.

19-20. (canceled)
